(19) United States
(12) Patent Application Publication
(10) Pub. No.: US 2010/0227171 A1
(43) Pub. Date: Sep. 9, 2010

(54) SURFACE COATING AND RESTORATION

(76) Inventor: Gene Raymond Thomas, Frederick, MD (US)

Correspondence Address: General Counsel, P.C., 6862 Elm Street, SUITE 800, McLean, VA, 22101, US

(21) Appl. No.: 12/399,099

(22) Filed: Mar. 6, 2009

(51) Int. Cl. B32B 27/38; B05D 3/14

(52) U.S. Cl. 428/414; 427/140

(57) ABSTRACT

A surface coating system and process and a construction surface restoration system and process are disclosed that utilize advantageous protective materials as coating and filling media. The bonding characteristics of the protective materials are such that surfaces coated with the protective materials and process possess improved and more diversified force absorption attributes. The filler material is capable of imitating pre-existing construction surfaces and possesses a substantial longevity.

### FIELD OF THE INVENTION

The present invention relates to the field of construction and renovation and more specifically to the field of surface coating and restoration.

### BACKGROUND

Man-made surface do not last forever; and even relatively long-lasting surfaces may not age gracefully. Surfaces that absorb considerable amounts of shock or environmental effects may crack, chip, or crumble under stress. One of the most harshly treated domestic surfaces, the garage, receives strong attention from the homeowner in his attempts to prolong its longevity. These forms of protection may include mats, tiles, or even a distinct surface coating. The aforementioned surface coatings typically include a polymer coating adapted to evenly spread throughout the garage surface—and may sometimes further include a distinct shiny top coat. However, existing garage surface coatings include materials adapted to form strong internal bonds (i.e., to itself) rather than bond with the surface upon which they sit. This bonding discrepancy often causes garage surface coatings to chip, or even peel, like low-quality paint when even a minute portion of the surface coating is penetrated.

Existing garage surface coatings focus on the ease of spreading coupled with the ability to last a handful of years. The surface coatings are not considered to have, nor are they designed to possess, the longevity of the surface that they cover. Although current garage surface coatings require infrequent replacement, the scale of the replacement is such that no, or perhaps a single, replacement would be a marked improvement.

Therefore, there is a need for surface coating and restoration product, and method for applying the product, capable of enhanced vertical and horizontal surface bonding and that allows imitation of a surface to be repaired.

### SUMMARY

The present invention is directed to a surface coating and construction restoration system and process. The construction restoration system of the present invention includes a target surface having one or more cavities. A filler material resembling the construction material of the construction surface, i.e. it is aesthetically matching, is placed within the cavity to form a continuously flush surface that includes the construction surface and an exposed surface portion of the filler material. The filler material includes a mixture of mineral granules and a formulated epoxy resin. The preferred range of mixture ratios for the mineral granules to formulated epoxy resin ranges from 40:1 lbs/gallon to 100:1 lbs/gallon. The system may further include a substantially translucent polymer layer that encompasses the entirety of the exposed filler material surface and portions of the construction surface.

The construction restoration process of the present invention includes forcefully probing with a sliding instrument the construction surface to check the strength of the construction surface. The structural integrity of the interior of the target surface is tested acoustically. The filler material is then mixed to the restoration mixture ratio of between 40:1 lbs/gallon and 100:1 lbs/gallon. The substantially translucent polymer layer is then placed upon the construction surface and the exposed filter material surface.

The surface coating system of the present invention includes a construction surface coated by at least one protective stratum, which is in turn coated by at least one resistance stratum. The construction surface includes sizable residential and commercial surfaces exposed to the environment and having substantially uniform compositions. The surface may be horizontal, vertical, and positions therebetween. The preferred protective stratum is formed from a formulated epoxy resin composed of a hardened epoxy resin modified with at least one gylcidyl ether and an effective hardener. The resistance stratum preferably includes a polymer resistant to ultraviolet light reactions.

The surface coating process of the present invention includes preparing a formulated epoxy resin protective material formed from a reaction between an epoxy resin modified with at least one gylcidyl ether and an effective hardener. The construction surface is coated with at least one protective stratum of the protective material. Granules are then distributed upon the protective stratum to create a granule-reinforced, protective stratum. The process further includes preparing a formulated epoxy resin resistance material formed from a reaction between an epoxy resin modified with alkyl gylcidyl ether and an effective hardener. The protective stratum is coated with at least one ungranulated stratum of said resistance material.

Therefore, it is an aspect of the present invention to present a restorative product and process and surface coating system and process capable of inexpensive application.

It is a further aspect of the present invention to present a restorative product and process and surface coating system and process capable of relatively speedy application.

It is a further aspect of the present invention to present a restorative product and surface coating system capable of disguised use.

It is a further aspect of the present invention to present a restorative product and surface coating system capable of substantial longevity.

It is a further aspect of the present invention to present a surface coating system substantially impervious to diverse elemental effects.

It is a further aspect of the present invention to present a surface coating system substantially impervious to diverse elemental effects.

It is a further aspect of the present invention to present a surface coating system capable of application on surfaces having diverse orientations.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the surface coating process of the present invention.

FIG. 2 is a view of the surface coating process of the present invention.

FIG. 3 is a view of the construction restoration process of the present invention

FIG. 4 is a view of the surface coating system of the present invention.

FIG. 5 is a view of the construction restoration system of the present invention.

### DETAILED DESCRIPTION

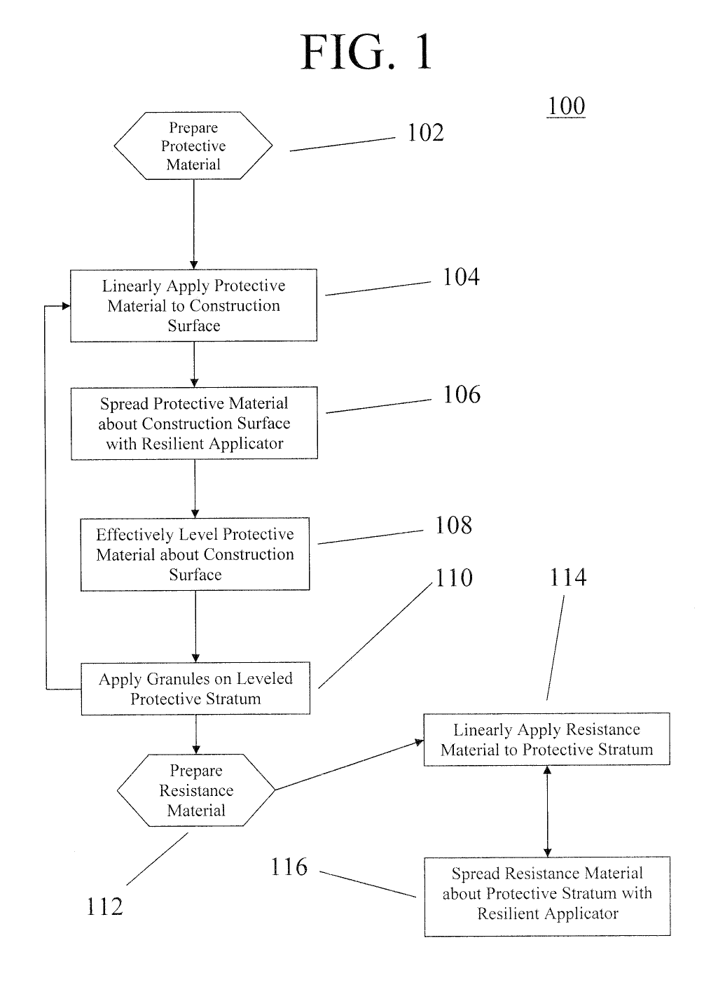

Referring first to FIG. 1, a basic embodiment of the surface coating process 100 is shown. The surface coating process includes preparing 102 a protective material that includes a formulated epoxy resin. The preferred formulated epoxy resin of the protective material, and protective stratum, includes a polymer derived from a reaction between an epoxy resin modified with multiple gylcidyl ethers and an effective protective hardener. The epoxy resin of the present invention may include any epoxy resin known in the art, that when modified with a combination of multiple gylcidyl ethers, conforms to the objects and advantages of the present invention. A formulated epoxy resin is an epoxy resin that has catalyzed upon substantial contact with a mating hardener or curing agent.

The preferred hardener for the protective material epoxy resin of the present invention includes a combination of: fatty acids, tall oil, and reaction products with Tetraethylenepentamine (“TEPA”); Diethylenetriamine (“DETA”) reaction products and ethylene oxide; and nonyl phenol oil. Other hardeners supplying the appropriate properties include those containing polyoxypropylenediame, triethanolamine and piperazine. Appropriate hardeners, and the protective materials for which they harden, are supplied by EPIC RESINS of Epic Corporation, Palmyra, Wis. as products R3532/H5099 and R3532/H5096-01 (epoxy resin with hardener). The above hardeners act upon the epoxy resin of the present invention to more suitably maintain a formulated epoxy's generally high degree of viscosity that allows the formulated epoxy a degree of adhesion, toughness, and migratory stability not currently found in the prior art. The epoxy resin of the present invention is mixed, preferably at temperatures around 10 degrees Celsius, with the hardener of the present invention to create the formulated epoxy resin of the protective material. R3532/H5099 is mixed at a ratio by volume of 2:1, and ratio by weight at 100:42 respectively, to achieve a cured shore D hardness of 72-77.

The protective material is then applied 104 to a construction surface. It is preferred that the protective material is poured gradually in a linear fashion from a first edge of the construction surface to a distal edge of the construction surface. The elongated mass of poured protective material is then spread 106 transversely from the poured mass upon the construction surface. A preferred spreading instrument includes a resilient NEOPRENE squeegee. Although stiff-bladed squeegees are often used, in addition to margin trowels and floats, to apply adhesive when working with a surface, resilient spreading instruments are preferred for the present invention as they assist in stretching the highly viscous protective material of the present invention about the construction surface and removing air from the materials as they are applied.

Indeed, the viscosity of the protective material is substantial enough to allow the coating process 100 of the present invention to be performed on surfaces oriented other than horizontally, and in many cases upon vertical surfaces. For vertical applications of the protective material, it is preferred that the protective material be heated during creation and non-use to a temperature between 18 degrees Celsius and 24 degrees Celsius.

The construction surface of the present invention is a mineral-based, man-made surface. It is required in most instances that the construction be substantially planar in at least one meter by one meter intervals such that the protective material may be spread thereon with appropriate tools. By substantially planar it is meant that the surface does not include multiple, inherent surface aberrations that serve to interfere drastically with a substantially linear contact surface of a spreading mechanism, e.g. a roller, a squeegee, and the like. Substantially planer surfaces may include, for example, the curving side surfaces of a large cylinder's interior and other sloping surfaces that are near planar along a one meter by one meter interval. By mineral-based, it is meant that a material is a mineral, aggregate of a mineral, derived from minerals, or is a construction material that is not primarily organic in nature and used in the fabrication of a commercial, residential, or industrial structure adapted to support weight. Examples of commercial surfaces include floors, roads and driveways, walls, non-wooden roofs, container interiors and exteriors, and the like.

Due to the weight supporting nature of the construction surfaces and the required viscosity of the protective material it is further preferred that the construction surfaces be affixed to a supporting surface in a pre-existing orientation. The viscosity of the protective material of the present invention is such that the protective material must be forcefully applied with substantial pressure. Affixed, when used in conjunction with the construction surfaces, includes attachments to a supporting surface in at least one position that prevents the construction surface from dislocating in the face of the application of the protective material.

After the protective material has been spread 106 across the construction surface, the protective material is then leveled 108. As is the case with epoxies currently used in the art, the protective material of the present invention is to a large degree self-leveling; however, unlike other epoxies used in the art of surface coating, the protective material includes a viscosity that prevents sufficient self leveling at a rate appropriate to the hardening time. To assure appropriate leveling, it is preferred that the protective material is manually or automatically leveled with the assistance of instruments. A preferred leveling instrument includes an eighteen inch (45.72 cm) roller with a half inch (1.27 cm) nap.

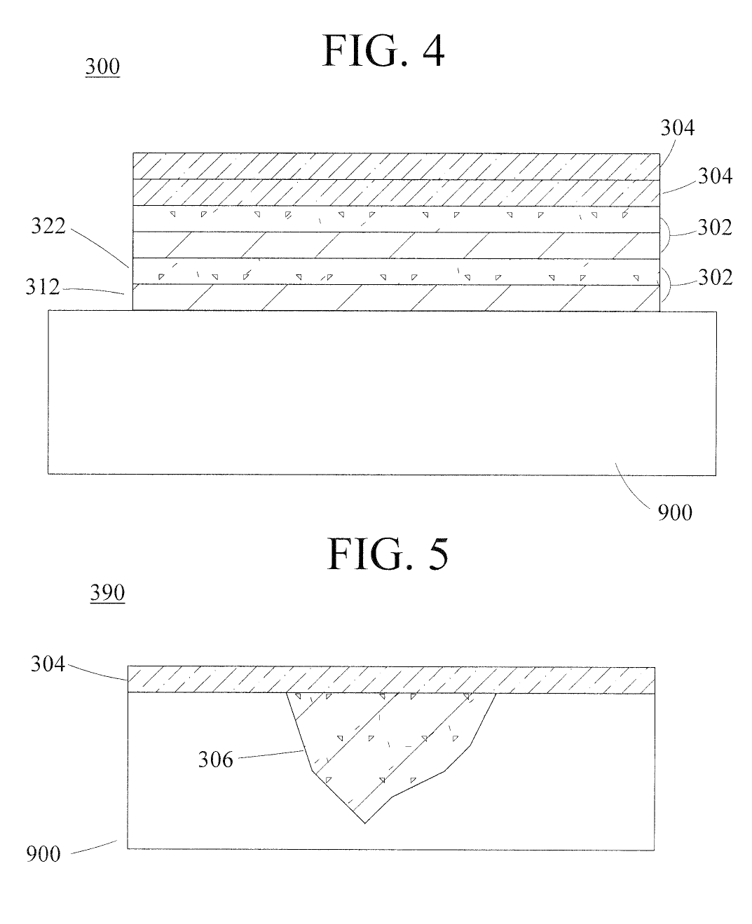

As FIG. 4 and FIG. 1 show, after the protective material 312 is effectively leveled 108 about the construction surface, the protective material 312 is then seeded 110 with granules 322 to form the protective stratum 302. The preferred granule of the present invention includes quartz, but any granules used in the surface protection art may be used with the present invention such as ceramic or glass. It is preferred that the diameter of the quartz portions used is roughly equivalent to the height of the protective stratum. The granules will adhere and sink into the protective material and be substantially flush with the upper surface of the protective stratum. After the protective stratum hardens completely on the construction surface, a second protective stratum may be applied thereon. As FIG. 4 shows, protective stratum 302 may be placed over protective stratum 302 in the surface coating system 300 to the extent and number desired to protect the construction surface 900.

Returning to FIG. 1, a resistance material is prepared 112. The resistance material of the present invention includes a formulated epoxy resin adapted to nullify or resist the effects of ultraviolet (UV) light on the protective stratum and itself. The resistance material is substantially translucent in that it allows the protective stratum to be viewed when placed in a single layer upon the protective stratum. Surface coating polymers have a tendency to fade in environment rich in UV radiation. The resistance material is a constituent of a resistance stratum that is formed as the resistance material is spread 114 about a protective stratum. It is preferred that the resistance material is spread and leveled about the protective stratum in a fashion similar to that of spreading the protective material.

It is preferred that the resistance material is poured gradually in a linear fashion from a first edge of the protective stratum to a distal edge of the protective stratum. The elongated mass of poured resistance material is then spread 116 transversely from the poured mass upon the protective stratum. A preferred spreading instrument includes a resilient NEOPRENE squeegee. Due to the viscosity of the resistance material, which is similar to that of the protective material, resilient spreading instrument are preferred for the present invention as they assist in stretching the highly viscous resistance material of the present invention about the protective stratum or resistance stratum.

Turning to FIG. 4, the resistance stratum 304 composed primarily of the resistance material. Granules need not be added. The resistance material may be layered multiple times into multiple strata. It is a prime advantage of the present invention that both the protective material 322 and resistance material 304 form bond strengths to external compositions comparable to those of their internal bonding. That is to say, the protective material bonds to the construction surface to a degree comparable to the bonds formed between neighboring molecules of the protective material. Similarly, the resistance material bonds to the protective stratum to a degree comparable to the bonds formed between neighboring molecules of the protective material. The bonding nature of the present invention permits the protective material to protect the construction surface from forces parallel to the construction surface, to prevent peeling as well as perpendicular thereto, to prevent chipping and cracking.

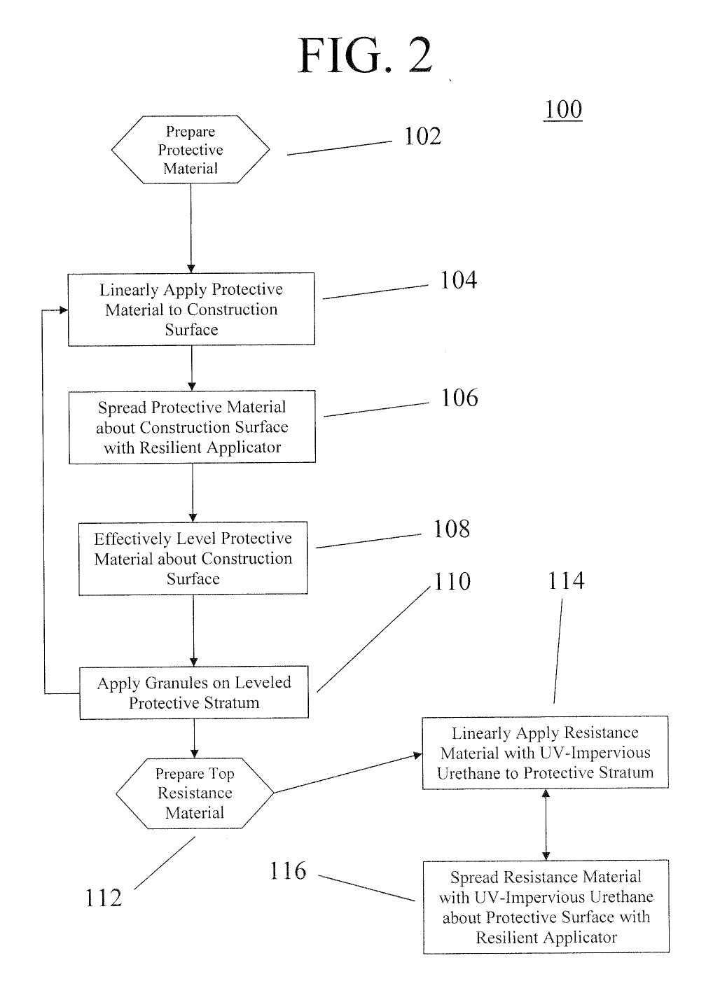

The preferred resistance material of the present invention includes a two component formulated epoxy resin of an epoxy resin modified with alkyi glycidyi ether to reduce viscosity and cured with polyoxypropylenediame, triethanolamine, and piperazine. The resistivity of the aforementioned formulated epoxy resin is substantial. In extreme UV-rich conditions, as FIG. 2 shows, an aliphatic polyurethane with a polycaprolactone oxydiethylene ester mixed with epsilon-caprolactone polymer with trimethylolpropane cured with a Dicyclohexylmethane 4′4 Diisocyanate prepolymer may be applied 114 and spread 116 upon the protective stratum. Appropriate resins and curing agents are supplied by EPIC RESINS of Epic Corporation, Palmyra, Wis. as products X01H3458, S7427A/B, and D9980A/B. X01h3458 is preferably mixed by volume at 2:1 and by weight at 100:42.8 to achieve a shore D hardness of 75-85. D9980A/B is preferably mixed by volume at 1:1 and by weight at 100:97 to achieve a shore D hardness of 75-80. Although cured and hardened are ostensibly synonyms for the mixture of a polymer agent with its solidifying catalyst, the term “hardener” is used with protective materials and the term “curing agent” is used with resistance materials for purposes of clarity.

The protective stratum of the present invention that contacts the construction surface is characterized by a construction surface to protective stratum bond strength approximately equal to an inter-stratum bond strength. That is to say that a parallel initial threshold force required to dislocate a portion of the protective stratum from the construction surface is comparable in magnitude to a perpendicular initial threshold force required to dislocate a portion of said protective stratum from the construction surface. This property is particularly substantial at the juncture between the construction surface and the protective surface. A protective material of the present invention resists rolling and peeling and ensures unexpected bond longevity between the construction surface and the protective surface.

Furthermore, the present invention may include additives to the epoxy resin compositions or formulations for providing additional attributes to the systems of the present invention. For example, brominated fire-retarding agents or hydrated aluminum oxide may be added to any mixture of the present invention.

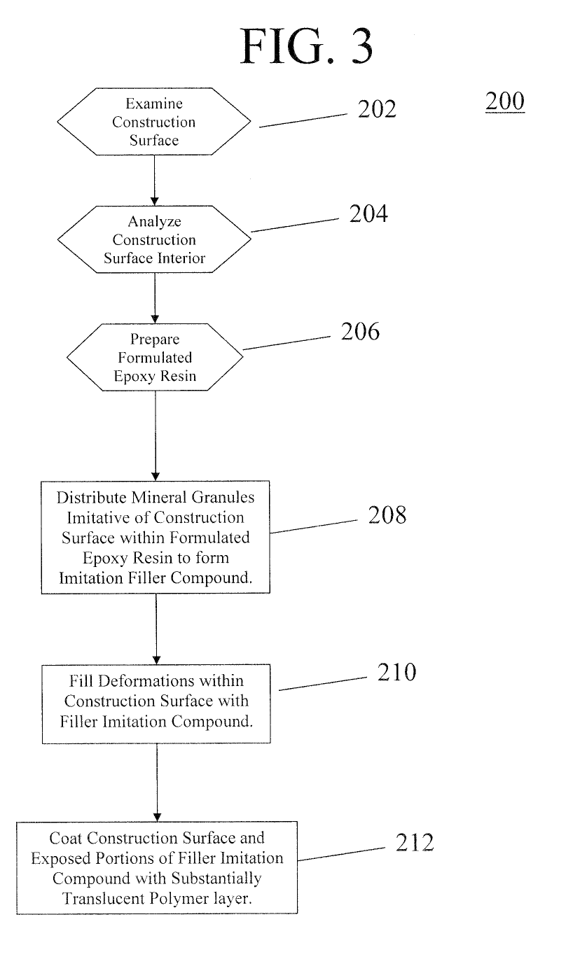

Turning to FIG. 3, a construction restoration process 200 of the present invention includes forcefully probing 202 with a sliding instrument the construction surface to check the strength of the construction surface. The structural integrity of the interior of the target surface is tested 204 acoustically. Weaknesses in the construction surface may be further tested to determine whether the surface should be maintained or removed.

A filler material is then mixed 206. When FIG. 3 is viewed in tandem with FIG. 5, the preferred filler material 306 of the present invention includes the protective material mixed with granules resembling construction materials used in creating the construction surface. As the construction surface of the present invention includes minerals—i.e. a mineral, aggregate of a mineral, derived from minerals, or is a construction material that is not primarily organic in nature and used in the fabrication of a commercial, residential, or industrial structure adapted to support weight; the process 200 and system 390 utilize granules resembling the original materials. For example, construction surfaces 900 created from stucco, cinder block, or cement can be imitated by the use of cement granules mixed with the protective material to form the filler material 306.

The preferred restoration mixture for the filler material is between forty to one pounds of cement per gallon of protective material and one-hundred to one pounds of cement per gallon of protective material, and most preferred, eighty pounds of cement per gallon of protective material. Other mineral granules should be mixed in similar proportion with the protective material. The filler material 306 is then placed in a cavity created by the construction surface to occupy that space. The surface of the placed filler material 306 is then leveled and allowed to harden completely. It is then preferred that a layer of resistance material in a stratum 304 over the filler material, or alternatively over the filler material 306 and the construction surface 900.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A construction restoration system comprising:
a substantially planar mineral-based construction surface having construction surface aesthetics and defining a cavity; and
a filler material, positioned within said cavity to form an exposed substantially planer filler material surface substantially flush with said construction surface, characterized by a mixture of mineral granules substantially imitative of said construction surface aesthetics and a formulated epoxy resin at a restoration mixture ratio of at least 40:1 lbs/gallon, wherein said formulated epoxy resin is adapted to permanently bond with a mineral-based surface.

2. The system of claim 1 further comprising a substantially translucent polymer layer upon said target surface and said exposed filler material surface.

3. The system of claim 2 wherein said substantially translucent polymer layer covers the entirety of said target surface and said exposed filler material surface.

4. The system of claim 2 wherein said restoration mixture ratio is at least 60:1 lbs/gallon.

5. The system of claim 4 wherein said restoration mixture ratio is at least 80:1 lbs/gallon.

6. The system of claim 5 wherein said restoration mixture ratio is at least 100:1 lbs/gallon.

7. The system of claim 1 wherein said mineral granules consist of granules selected from a group consisting of cement, concrete, granite, marble, and combinations thereof.

8. The system of claim 1 further comprising a restoration surface comprising less than three sublayers of said filler material, positioned within said cavity to form an exposed substantially planer filler material surface substantially flush with said construction surface, characterized by a mixture of mineral granules substantially imitative of said construction surface aesthetics and a formulated epoxy resin at a restoration mixture ratio of at least 40:1 lbs/gallon

9. The system of claim 1 further comprising a restoration surface formed from a reaction between an epoxy resin modified with at least one gylcidyl ether hardened with fatty acids, tall Fatty acids, and tall oil; DETA reaction products and ethylene oxide; and nonyl phenol oil.

10. A construction restoration process comprising:
forcefully probing with a sliding instrument a substantially planar, mineral-based construction surface having target surface aesthetics and defining a cavity;
acoustically testing an interior of said construction surface;
mixing a filler material having mineral granules substantially imitative of said construction surface aesthetics and a formulated epoxy resin at a restoration mixture ratio of at least 40:1 lbs/gallon;
positioning said filler material within said cavity to form an exposed substantially planer filler material surface substantially flush with said construction surface; and
forming a substantially translucent polymer layer upon said construction surface and said exposed filler material surface.

11. The process of claim 10 wherein said forming step includes forming a substantially translucent polymer layer upon the entirety of said construction surface and said exposed filler material surface.

12. The process of claim 11 wherein said mixing step includes mixing said filler material having mineral granules substantially imitative of said construction surface aesthetics and said formulated epoxy resin at said restoration mixture ratio of at least 60:1 lbs/gallon.

13. The process of claim 12 wherein said mixing step includes mixing said filler material having mineral granules substantially imitative of said construction surface aesthetics and said formulated epoxy resin at said restoration mixture ratio of at least 80:1 lbs/gallon.

14. A surface coating system comprising:
a substantially planar construction surface affixed in a pre-determined orientation;
at least one granule-reinforced, protective stratum, contacting said construction surface, formed from a formulated epoxy resin characterized by a construction surface to stratum bond strength approximately equal to a inter-stratum bond strength whereby a parallel initial threshold force required to dislocate a portion of said protective stratum from said construction surface is comparable in magnitude to a perpendicular initial threshold force required to dislocate a portion of said protective stratum from said construction surface;
at least one ungranulated, substantially translucent resistance stratum, contacting said protective stratum, composed of a polymer resistant to ultraviolet light reactions.

15. The system of claim 14 wherein said formulated epoxy resin is formed from a reaction between an epoxy resin modified with multiple gylcidyl ethers and a hardener including: fatty acids, tall Fatty acids, and tall oil; DETA reaction products and ethylene oxide; and nonyl phenol oil.

16. The system of claim 15 wherein said resistance stratum is formed from a reaction between an epoxy resin modified with alkyl gylcidyl ether and an effective curing agent.

17. The system of claim 15 wherein said resistance stratum is formed from a reaction between an epoxy resin modified with alkyl gylcidyl ether and an effective curing agent including polyoxypropylenediamine, triethanolamine, and piperazine.

18. The system of claim 17 wherein said formulated epoxy resin is formed from a reaction between an epoxy resin modified with multiple gylcidyl ethers and a hardener including polyoxypropylenediamine, triethanolamine, and piperazine, wherein said protective stratum is adapted to permanently bond with a mineral-based surface.

19. The system of claim 14 wherein said resistance stratum is formed from a reaction between an aliphatic polyurethane including polycaprolactone oxydiethylene ester mixed with epsilon-caprolactone polymer with trimethylolpropane and a curing agent including a Dicyclohexylmethane 4′4 Diisocyanate prepolymer.

20. A surface coating process for protection a substantially-planar construction surface, said process comprising:
coating the construction surface, affixed in a pre-determined orientation, with at least one protective stratum of a protective material formed from a formulated epoxy resin characterized by a construction surface to stratum bond strength approximately equal to a inter-stratum bond strength whereby a parallel initial threshold force required to dislocate a portion of said protective stratum from said construction surface is comparable in magnitude to a perpendicular initial threshold force required to dislocate a portion of said protective stratum from said construction surface;
distributing granules upon said protective stratum to create a granule-reinforced, protective stratum;
preparing a substantially translucent formulated epoxy resin resistance material formed from a reaction between an epoxy resin modified with alkyl diluent gylcidyl ether and an effective resistance hardener; and
coating said protective stratum with at least one ungranulated stratum of said resistance material.

21. The process of claim 20 wherein said construction surface coating step includes preparing a formulated epoxy resin protective material formed from a reaction between an epoxy resin modified with multiple gylcidyl ethers and an effective hardener including: fatty acids, tall Fatty acids, and tall oil; DETA reaction products and ethylene oxide; and nonyl Is phenol oil.

22. The process of claim 21 wherein said coating step includes linearly applying said protective material upon said substantially-planar construction surface; and transversely spreading said protective material about said substantially-planar construction surface.

23. The process of claim 22 wherein coating step includes coating a substantially-planar, substantially vertical construction surface, affixed in a pre-determined orientation, with at least one protective stratum of said protective material;

24. The process of claim 23 wherein said preparing step includes heating said formulated epoxy resin protective material to between 18 degrees Celsius and 24 degrees Celsius.

25. The process of claim 20 wherein said construction surface coating step includes preparing a formulated epoxy resin protective material formed from a reaction between an epoxy resin modified with multiple gylcidyl ethers and an effective hardener including polyoxypropylenediamine, triethanolamine, and piperazine.

26. The process of claim 25 wherein said coating step includes linearly applying said protective material upon said substantially-planar construction surface; and transversely spreading said protective material about said substantially-planar construction surface.

27. The process of claim 26 wherein coating step includes coating a substantially-planar, substantially vertical construction surface, affixed in a pre-determined orientation, with at least one protective stratum of said protective material;

28. The process of claim 27 wherein said preparing step includes heating said formulated epoxy resin protective material to between 18 degrees Celsius and 24 degrees Celsius.
